(19) United States
(12) Patent Application Publication
(10) Pub. No.: US 2018/0235032 A1
(43) Pub. Date: Aug. 16, 2018

(54) ELECTRICAL DEVICE WITH TUBULAR METAL SHEATHING AND INSULATING ELEMENT HELD THEREIN

(71) Applicant: Tuerk & Hillinger GmbH, Tuttlingen (DE)

(72) Inventor: Andreas SCHLIPF, Tuttlingen (DE)

(21) Appl. No.: 15/895,129

(22) Filed: Feb. 13, 2018

(30) Foreign Application Priority Data
Feb. 15, 2017 (DE) 20 2017 100815.0

(51) Int. Cl. H05B 3/44; G01K 1/08

(52) U.S. Cl. CPC H05B 3/44; G01K 1/08

(57) ABSTRACT

Electrical device with a tubular metal sheathing and at least one insulating element arranged within the tubular metal sheathing with at least one hole, wherein, within the hole, an electrical contact is produced between a conductor of a supply line and/or of a data line and a conductor of the electrical device, wherein the insulating element has at least one window that exposes a section of the hole or has at least an opening that exposes at least a section of the hole and that in the area of the window or the opening there is a welded contact, a soldered contact, or a crimped contact that produces the electrical contact between the conductor of the supply line and/or of the data line and the conductor of the electrical device.

### CROSS-REFERENCE TO RELATED APPLICATIONS

This application claims priority under 35 U.S.C. § 119(b) to German Application No. 20 2017 100 815.0, filed Feb. 15, 2017, the disclosures of which is incorporated herein by reference in its entirety.

### BACKGROUND OF THE INVENTION

The invention relates to an electrical device with the features of the preamble of claim 1, in particular, electrical heating cartridges and sheathed temperature sensors, such as, e.g., sheathed thermocouples and PTC/NTC temperature sensors that are arranged in a tubular metal sheathing with or without a base.

Such electrical devices typically must be connected to a supply line and/or data line to be able to operate, i.e., an electrically conductive connection must be established between this supply line and/or data line and a conductor of the electrical device—more specifically, for the case of a heating cartridge, the electrical heating element that can be designed, e.g., as a resistive wire, or for the case of a sheathed temperature sensor, its supply line, or for, e.g., the case of a sheathed thermocouple, one thermal conductor of the thermocouple. Here, it is desirable to arrange this electrically conductive connection inside of the metal sheathing, because this arrangement reliably guarantees excellent mechanical stress relief on the connection and protection from interfering environmental effects.

One well established method that has been known for many years consists in producing a press-fit contact in an insulating element that can be made, in particular, from ceramic. To do this, a section of the conductor of the electrical device and a section of the conductor of the supply line and/or data line each without insulation are introduced into a hole of an insulating element so that they overlap each other at least in some sections, the insulating element is brought into the interior of the tubular metal sheathing, optionally any remaining empty volume is filled with a material that has electrically insulating, but usually good heat-conducting properties, e.g., MgO powder, and then a press-fit contact is produced by radial compacting (i.e., compacting in the direction from the lateral surface of the tube toward the tube center of the tubular metal sheathing) between conductor sections introduced into the hole.

This procedure has proven effective for many years, but there is still potential to improve it. It can happen that insulating material powder penetrates into the hole, finds its way between the conductor sections that are to be connected to each other, and consequently degrades or blocks the electrical contact between these parts. Even if a contact is still made, this can cause increased contact resistance for the conductors contacting each other, which can cause significant fluctuations in the properties of the electrical device, especially for applications with low voltage, low ohmic impedance values, high surface loading, high current density, high operating temperatures, and high current loading, which, in light of ever stricter tolerance ranges demanded by users, e.g., in the medical technology or automotive sectors, are increasingly viewed as problematic. A contributing factor here is that the contact achieved by compacting and especially the position of contact locations cannot be predicted exactly or cannot be specified exactly and only a linear contact is created that has a greater contact resistance and thus contributes to more inexact measurements/regulation.

### BRIEF SUMMARY OF THE INVENTION

The problem of the invention is therefore to disclose an electrical device with a tubular metal sheathing in which a better defined electrical contact arranged within the tubular metal sheathing is guaranteed between a conductor of the device and a conductor of the supply line and/or data line. In particular, it is desirable here that the contact resistance is minimized, and the process reliability is increased.

This problem is solved by an electrical device with the features of claim 1. Advantageous refinements of the invention are the subject matter of the dependent claims.

The electrical device according to the invention has a tubular metal sheathing that can be constructed with or without a base, and at least one insulating element arranged inside of the tubular metal sheathing with at least one hole, i.e., an opening passing through the insulating element in the direction of its extent. Here, an electrical contact of a conductor of a supply line and/or data line to a conductor of the electrical device is created within the hole.

It is essential to the invention that the insulating element has at least one window that exposes a section of the hole or has at least an opening that exposes a section of the hole and that in the area of the window or the opening, there is a welded contact, a soldered contact, or a crimped contact that produces the electrical contact between the conductor of the supply line and/or data line and the conductor of the electrical device.

Here, a window is formed when an opening is present in the insulating element that allows access through the insulating element to the hole and is surrounded, while an opening is formed if such an opening is not completely surrounded, as is the case, for example, when the opening is on the periphery, i.e., when it is located on an end side of the insulating element.

It should be noted that the window or the opening in the insulating element naturally must be open only until the electrical connection is made by welding, soldering, or crimping. Then it can be and normally will be closed, e.g., by MgO powder.

By providing a window or an opening in the insulating element, it is possible to produce a defined and testable contact at a well-defined location of the electrical device, in which a smaller contact resistance is normally achieved. Accordingly, a noticeable reduction in the variance of the properties of the electrical device is achieved and the process reliability is significantly increased. The latter applies especially when a press-fit contact is also produced, as before, by compacting the electrical device.

Another advantage is that the electrical device according to the invention requires a shorter overlap of the conductors in the hole than was previously the case.

In a first preferred embodiment, the electrical device is a heating cartridge with an electrical resistive element wound on a winding form, wherein the winding form is formed by the insulating element.

In one alternative preferred embodiment, the electrical device is a sheathed temperature sensor, e.g., a sheathed thermocouple or a PTC or NTC temperature sensor arranged in a metal sheathing.

It is especially preferred when a conductor of the supply line and/or data line and a conductor of the electrical device are guided in a parallel, antiparallel, or twisted arrangement at least in some sections in a shared hole.

It has proven especially advantageous when a conductor of the supply line and/or data line and a conductor of the electrical device are electrically contacted in the non-open area of the insulating element, especially when they are electrically contacted by means of a press-fit contact produced by compacting. Such a doubled design for the contacting increases the reliability even more. Accordingly, it is also considered advantageous if at least one conductor of the supply line and/or data line and one conductor of the electrical device are contacted to each other both by a press-fit contact and also be a soldered, crimped, or welded contact.

An especially reliable contact can be achieved if at least one conductor of the supply line and/or data line and/or if at least one conductor of the electrical device extends in the axial direction on both sides of a window within the hole.

The achievable contact can be improved even more if at least one conductor of the supply line and/or data line and one conductor of the electrical device are interconnected in a connection by means of a metallic connector, in particular, with a weld metal.

It can be further provided that the electrical heating element is wound in the area of the window with a greater winding pitch in order to simplify the production of an electrical contact through the window.

A method for producing such an electrical device also viewed as an invention includes the following steps
Preparing a tubular metal sheathing,
Preparing an insulating element that has at least one window that exposes a section of the hole or has at least one opening that exposes a section of the hole
Introducing a blank section of a conductor, i.e., a section without insulation or with the insulation stripped off, of a supply line and/or data line and a blank section of a conductor, i.e., a section without insulation or with the insulation stripped off, of the electrical device into the hole, so that both project inject the area of a window or opening,
Forming a welded contact, soldered contact, or crimped contact that produces the electrical contact between the conductor of the supply line and/or data line and the conductor of the electrical device, through the window or the opening,
Introducing the insulating element with the conductors contacting each other and any components connected thereto into the tubular metal sheathing, and
Filling the tubular metal sheathing with a powder that has electrically insulating and good heat-conducting properties, e.g., with MgO powder.

The first step can be performed at any time as long as it is performed before the insulating element is introduced. The other steps should be performed preferably in the specified sequence; but other processing steps can also be performed in between, for example, the winding of the insulating element with the resistive wire, if the electrical device is an electrical heating cartridge.

It should be emphasized, in particular, that it is possible for the device according to the invention or for the method according to the invention that the sections of the conductor of the electrical device and the sections of the conductor of the supply line and/or data line can be introduced from different sides into the holes of the insulating element.

In particular, the compacting of the electrical device, which was absolutely required in the previously typical method, is now optional in order to produce the contact between the conductor of the supply line and/or data line and the conductor of the electrical device. This allows pressure-sensitive components to also be arranged in the tubular metal sheathing, which brings along a considerable expansion of the functions that can be integrated.

On the other hand, it is to be noted that if compacting is nevertheless still performed, a press-fit contact formed in this way improves the contacting even more, which considerably reduces the risk, in particular, of total failure.

Optionally, a quality control step and/or testing of the produced electrical contact can now also be performed as an additional processing step before introducing the inner structure into the tubular metal sheathing.

Another important difference between the method according to the invention and the previous method consists in that, according to the invention, the contact is produced between the conductor of the supply line and/or data line and the conductor of the electrical device, while the corresponding module made from the insulating element, the conductor of the electrical device arranged thereon, and components of the electrical device and the supply line and/or data line connected or fastened thereto, especially the conductor that is designated below also as the inner structure of the electrical device, is still outside of the tubular metal sheathing, that is, can still be tested and characterized.

In contrast, this contact was conventionally produced only when the inner structure is already held in the tubular metal sheathing and thus is no longer accessible for quality inspection of the connection. As already mentioned above, however, it can still be useful to also produce such a press-fit contact.

### BRIEF DESCRIPTION OF THE SEVERAL VIEWS OF THE DRAWINGS

The foregoing summary, as well as the following detailed description of the invention, will be better understood when read in conjunction with the appended drawings. For the purpose of illustrating the invention, there are shown in the drawings embodiments which are presently preferred. It should be understood, however, that the invention is not limited to the precise arrangements and instrumentalities shown. In the drawings:

FIG. 1a: one embodiment of an electrical device,

FIG. 1b: the inner structure of the electrical device from FIG. 1a,

FIG. 1c: a detailed enlargement from FIG. 1a,

FIG. 2a: the inner structure of a second embodiment of an electrical device,

FIG. 2b: a first detailed enlargement from FIG. 2a,

FIG. 2c: a second detailed enlargement from FIG. 2a,

FIG. 2d: a variant of the inner structure from FIG. 2a,

FIG. 2e: a first detailed enlargement from FIG. 2d,

FIG. 2f: a second detailed enlargement from FIG. 2d,

FIG. 2g: a second variant of the inner structure from FIG. 2a,

FIG. 3a: the inner structure of a third embodiment of an electrical device, and

FIG. 3b: a detailed enlargement from FIG. 3a.

### DETAILED DESCRIPTION OF THE INVENTION

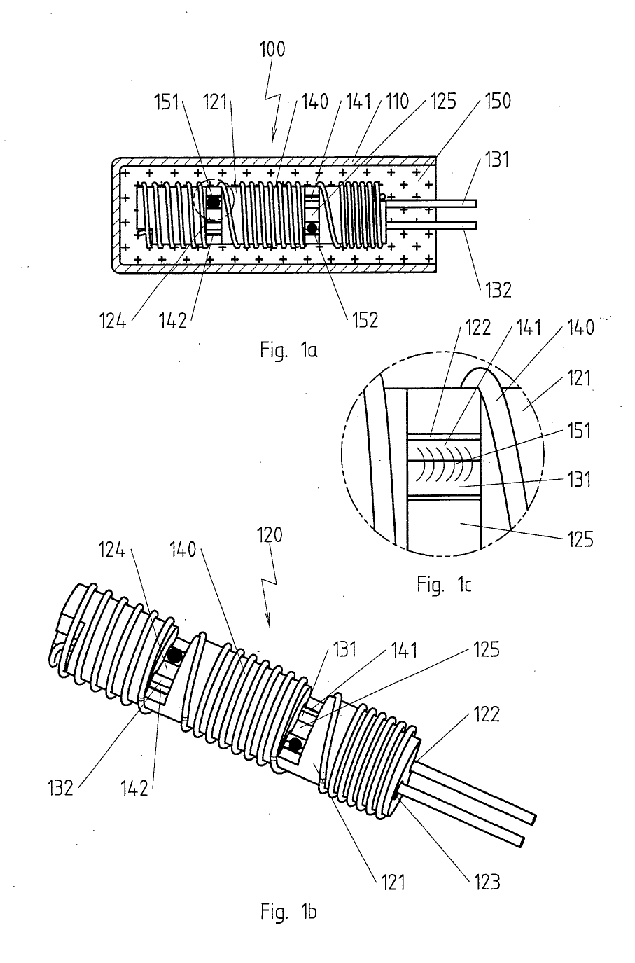

FIG. 1a shows an electrical device 100, with a tubular metal sheathing 110 and an inner structure 120 that makes the electrical device 100 into a heating cartridge.

The inner structure 120 that is shown separately in FIG. 1b has an essentially cylindrical insulating element 121 with two holes 122, 123 running in the direction of extent, that is, parallel to the cylinder axis of the cylindrical insulating element 121 and passing through the insulating element. A section of conductors 131, 132 of a supply line 130 that guarantees the power supply to the heating cartridges is introduced into the holes 122, 123 from the connection side of the electrical device 100. The two sections 141, 142 of a conductor of the electrical device 140 that is formed by the resistive wire of the heating cartridge wound on the insulating element 121 are also introduced into the holes 122, 123.

The insulating element 121 further has two windows 124, 125 that each expose a section of the two holes 122, 123. In this section, as is especially clearly shown in the detailed enlargement of FIG. 1c, a welded contact 151 between the section of the conductor 131 and the section 141 or analogously a welded contact 152 between the section of the conductor 132 and the section 142 has been formed, which is possible through the windows 124, 125.

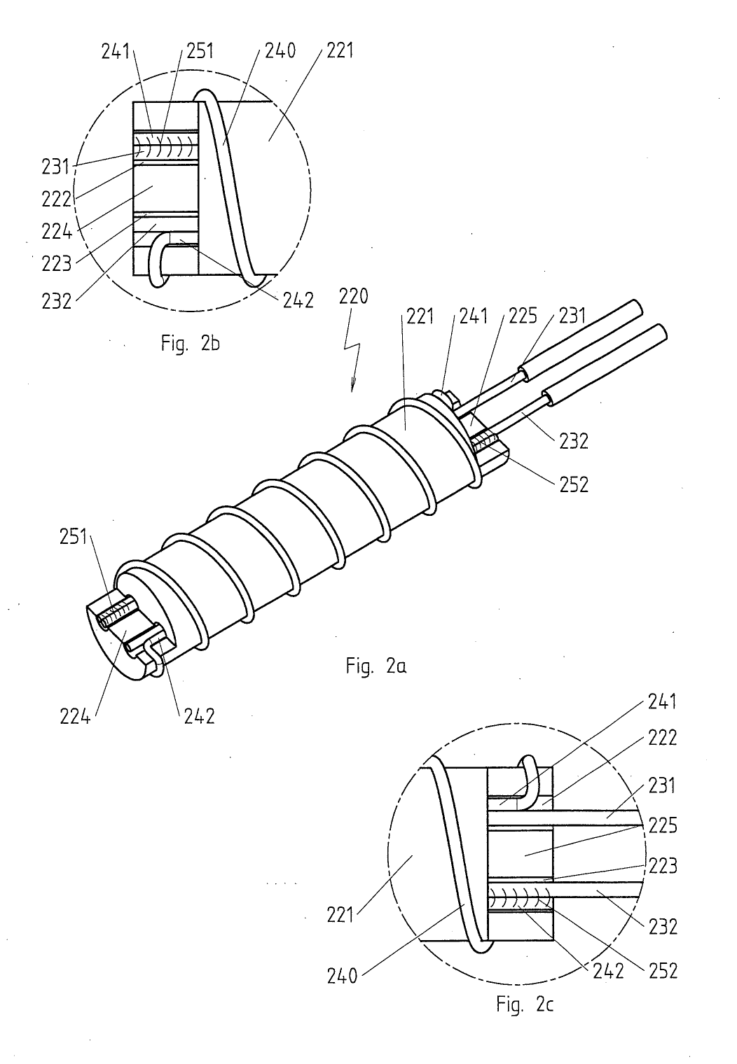

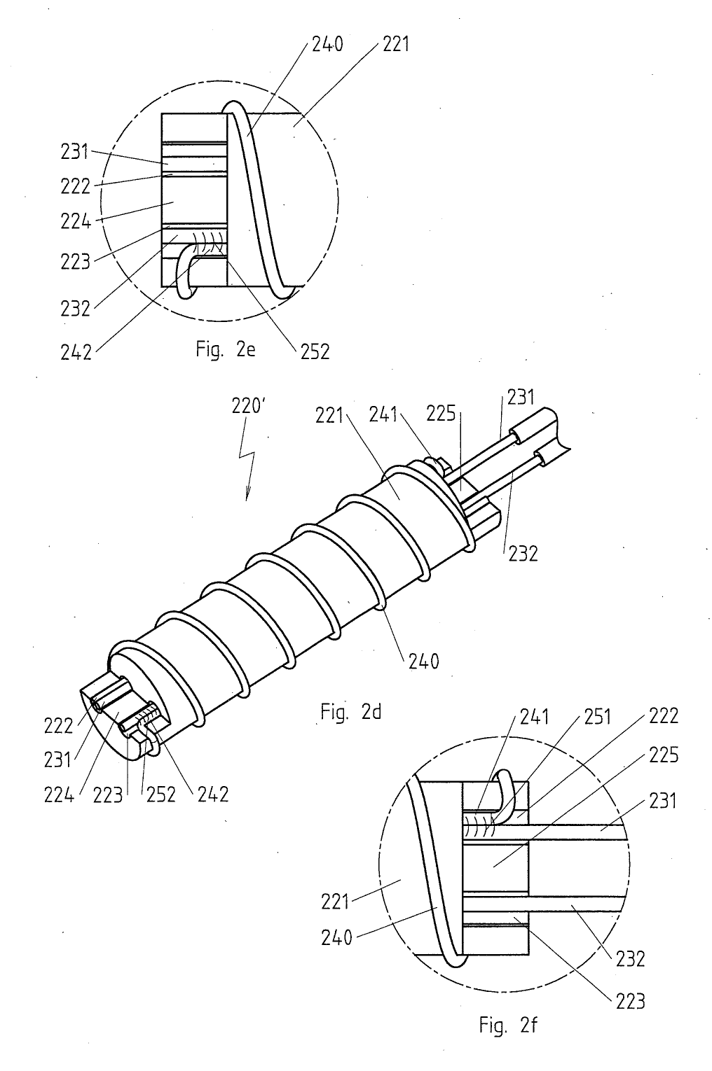

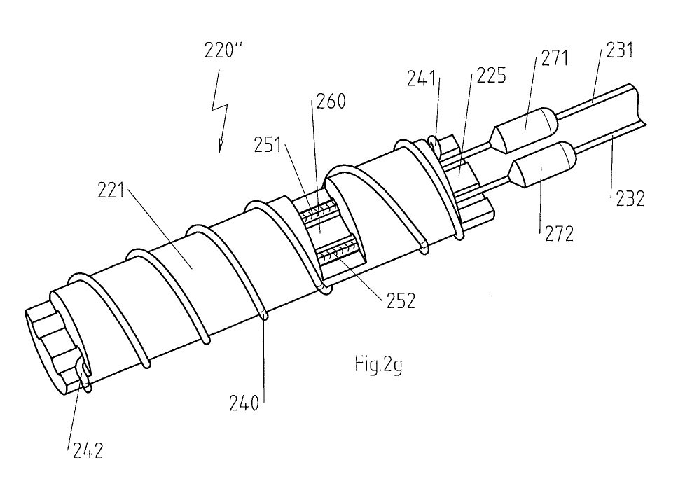

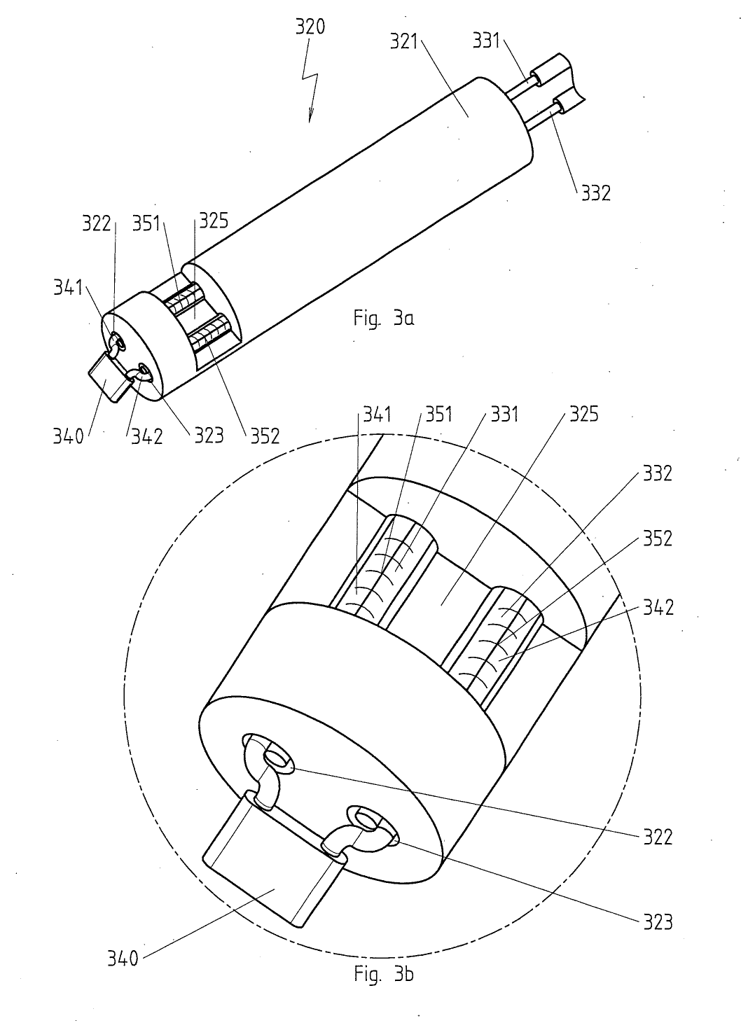

Such an inner structure 120 is then introduced into the tubular metal sheathing 110 in order to form the electrical device and embedded and optionally compacted in a material with electrically insulating and good heat-conducting properties, here MgO powder 150. This is clearly possible in the same way with the inner structures 220, 320 shown in FIGS. 2a to 2f and 3a, b, which is why only these components of the other embodiments presented here are shown and described.

The inner structure 220 shown in FIGS. 2a to 2c is also an inner structure for an electrical heating cartridge.

The inner structure 220 likewise has an essentially cylindrical insulating element 221 with two holes 222, 223 that each run in the direction of extent, that is, parallel to the cylinder axis of the cylindrical insulating element 221 and pass through the insulating element 222, 223. A section of conductors 231, 232 of a supply line 230 that guarantees the power supply to the heating cartridges is introduced from the connection side of the electrical device. The two sections 241, 242 of a conductor of the electrical device 240 that is formed by the resistive wire of the heating cartridge are also introduced into the holes 222, 223.

The insulating element 221 differs from the insulating element 121 in that it has no window 124, 125, but instead two openings 224, 225 that are arranged on the insulating element at the ends and expose a section of both holes 222, 223. In this section, as is especially clearly shown in the detailed enlargement of FIGS. 2b and 2c, a welded contact 251 has been formed between the section of the conductor 231 and the section 241 or analogously a welded contact 252 between the section of the conductor 232 and the section 242, which is possible through the openings 224, 225.

The variant of the inner structure 220′ shown in FIGS. 2d to 2f differs only in the selected position of the welded contacts 251 and 252, which is why the same reference symbols are used. While the welded contacts 251, 252 are provided in the inner structure 220 at the end of the holes at which the end of the respective section 241, 242 of the conductor 240 of the electrical device lies, so that this section runs through the entire hole 222 and 223, respectively, in the variant 220′ only a short section 241, 242 of the conductor is introduced into the hole 222 and 223, respectively.

The variant of the inner structure 220″ shown in FIG. 2g differs in the selected position of the welded contacts 251 and 252, which here lie in a window 260, and in that the conductors of the supply line 231, 232 each have a fuse 271, 272. Otherwise, the same reference symbols as in FIG. 1 are used. This embodiment shows that by means of the procedure according to the invention, the distance between a fuse 271, 272 and a welded contact 251, 252 can be increased so far that it is reliably produced that the heat introduced into the material during the welding does not cause pre-damage or melting of the fuse 271, 272.

The inner structure 320 shown in FIGS. 3a and 3b is the inner structure for a temperature sensor 340. Sections of conductors 341, 342 of the temperature sensor are introduced into holes 322, 323 of an essentially cylindrical insulating element 321, while from the opposite side of the insulating element 321, the conductors 331, 332 of a supply line 330 with blank sections are introduced into the holes 322, 323. As can be seen especially well in FIG. 3b, there is a window 324 in the insulating element 320, through which the welded contacts 351, 352 between the sections 341 and 342 of the conductor of the temperature sensor and the conductors 331 and 332, respectively, of the supply line were produced.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

I claim:

1. Electrical device (100) with a tubular metal sheathing (110) and at least one insulating element (121, 221, 321) arranged within the tubular metal sheathing (110) with at least one hole (122, 123, 222, 223, 322, 323), wherein, within the at least one hole (122, 123, 222, 223, 322, 323), an electrical contact is produced between a conductor (131, 132, 231, 232, 331, 332) of a supply line (130, 230, 330) and/or of a data line and a conductor (140, 240) of the electrical device (100), characterized in that the insulating element (121, 221, 312) has at least one window (124, 125, 324) that exposes a section of the at least one hole (122, 123, 222, 223, 322, 323) or has at least one opening (224, 225) that exposes at least one section of the at least one hole (122, 123, 222, 223, 322, 323) and that, in an area of the window (124, 125, 324) or the opening (224, 225), there is a welded contact (151, 152, 251, 252, 351, 352), a soldered contact, or a crimped contact that produces the electrical contact between the conductor (131, 132, 231, 231, 331, 332) of the supply line (130, 230, 330) and/or the data line and the conductor (140, 240) of the electrical device (100).

2. Electrical device (10) according to claim 1, wherein the electrical device is a heating cartridge with an electrical heating element that is wound on a winding form, wherein the winding form is formed by the insulating element (121, 221).

3. Electrical device (100) according to claim 1, wherein the electrical device (100) is a sheathed temperature sensor.

4. Electrical device (100) according to claim 1, wherein a conductor (131, 132, 231, 231, 331, 332) of the supply line (130, 230, 330) and/or of the data line and a conductor (140, 240) of the electrical device (100) are guided in parallel, antiparallel, or twisted into a common hole at least in some sections.

5. Electrical device (100) according to claim 1, wherein a conductor (131, 132, 231, 231, 331, 332) of the supply line (130, 230, 330) and/or of the data line and a conductor (140, 240) of the electrical device (100) are contacted electrically in a non-open area of the insulating element, in particular, contacted electrically by means of a press-fit contact formed by compacting.

6. Electrical Device (100) according to claim 5, wherein at least one conductor (131, 132, 231, 231, 331, 332) of the supply line (130, 230, 330) and/or of the data line and a conductor (140, 240) of the electrical device (100) are contacted with each other both by a press-fit contact and also by a soldered, crimped, or welded contact.

7. Electrical device (100) according to claim 1, wherein the conductor (131, 132, 231, 231, 331, 332) of the supply line (130, 230, 330) and/or of the data line and/or the conductor (140, 240) of the electrical device (100) runs in an axial direction on a side of the window and through the at least one hole.

8. Electrical device (100) according to claim 1, wherein the conductor (131, 132, 231, 231, 331, 332) of the supply line (130, 230, 330) and/or of the data line and the conductor (140, 240) of the electrical device (100) are interconnected in a connection by means of a metallic connector, in particular, are welded with a weld metal.

9. Electrical device (100) according to claim 2, wherein the electrical heating element is wound with a greater winding pitch in the area of the window.
